(19) United States
(12) Patent Application Publication
(10) Pub. No.: US 2018/0011575 A1
(43) Pub. Date: Jan. 11, 2018

(54) TOUCH WINDOW

(71) Applicant: LG INNOTEK CO., LTD., Seoul (KR)

(72) Inventors: Soo Kwang YOON, Seoul (KR); Sang Young LEE, Seoul (KR); Hyun Seok LIM, Seoul (KR); Young Jae LEE, Seoul (KR); Joon Jae OH, Seoul (KR)

(21) Appl. No.: 15/544,368

(22) PCT Filed: Dec. 29, 2015
(86) PCT No.: PCT/KR2015/014389

§ 371 Date: Jul. 18, 2017

(30) Foreign Application Priority Data
Jan. 21, 2015 (KR) 10-2015-0009925
Jan. 21, 2015 (KR) 10-2015-0010151
Jun. 8, 2015 (KR) 10-2015-0080897

(51) Int. Cl. G06F 3/041; G06F 3/047

(52) U.S. Cl. CPC G06F 3/0412; G06F 3/047; G06F 2203/04102; G06F 2203/04112; G06F 2203/04103

(57) ABSTRACT

A touch window according to the present invention comprises: a cover substrate; a resin layer on the cover substrate; a substrate on the resin layer; and an electrode on the substrate, wherein the resin layer is arranged with a thickness of 1 μm to 10 μm to prevent external defects that can occur when the touch window is bent or folded, such as exposure of the resin layer, or separation or damage to the cover substrate or substrate, thereby allowing improved reliability to be exhibited.

### BACKGROUND OF THE DISCLOSURE

### Field of the Disclosure

The present disclosure relates to a touch window.

### Related Art

In recent years, a variety of electronic products have included a touch window having a touch display unit with which an input device such as a finger or stylus is brought into contact.

The touch window may be formed in various types depending on a location of electrodes. For example, the electrodes may be formed on only one face of a cover substrate. Otherwise, the electrodes may be formed on one face of the cover substrate and one face of a substrate respectively.

When the touch window comprises the cover substrate and the substrate, the cover substrate and the substrate may be bonded together via an adhesive layer.

In this connection, when a thickness of the adhesive layer becomes larger, an overall thickness of the touch window becomes larger. Thus, when a flexible touch window is realized, a reliability thereof may be lowered due to such a larger thickness.

On the other hand, as the electrodes of the touch window, nanowires may replace indium tin oxide (ITO). Nanowires are superior to the indium tin oxide in various aspects such as transmittance and conductivity.

When forming such a nanowire as the electrode, there is a problem that an overcoating layer is further needed to prevent oxidation of the nanowires, thereby thickening the touch window.

Furthermore, when the electrode is patterned, various processes such as exposure, development and etching are required and, thus, the process efficiency is deteriorated.

In addition, wearable devices have been increasing in recent years. Users of these wearable devices are likely to use the devices while moving. Thus, easy inputting thereto without paying attention may be required.

Various electronic products require low power technology for long time use. Especially, the wearable devices are required to be slim to improve portability or wearing comfort.

Therefore, there is a need for a touch window with a novel structure that can solve such problems.

### SUMMARY OF THE DISCLOSURE

The present disclosure attempts to provide a touch window with reduced thickness and improved flexibility.

A touch window according to a first embodiment may include a cover substrate; a resin layer on the cover substrate; a substrate on the resin layer; and an electrode on the substrate, wherein the resin layer has a thickness in a range of 1 μm to 10 μm.

Furthermore, a touch window according to a second embodiment may include a substrate; and an electrode layer on the substrate, wherein the electrode layer comprises a first layer and a second layer, wherein the first layer comprises a photosensitive material.

Furthermore, a touch window according to a third embodiment may include a substrate; a first electrode on the substrate; and an electrode part on the substrate, wherein the electrode part include a base layer and a second electrode disposed on the base layer.

Furthermore, a touch sensor according to a fourth embodiment may include a substrate; a sensing electrode disposed on the substrate; and a conductivity conversion member disposed on the sensing electrode, wherein the sensing electrode includes a first sensing electrode and a second sensing electrode spaced from each other.

### Effects of the Present Disclosure

The touch window according to the first embodiment may have a small thickness. The touch window according to the first embodiment may formed by disposing the resin layer with the thickness in a range of 1 μm to 10 μm on the cover substrate, disposing the substrate on the resin layer and arranging the electrode on the substrate.

That is, the cover substrate and the substrate may be bonded with each other via the resin layer having the thickness of 1 μm to 10 μm. As a result, the thickness of the touch window can be reduced, and the flexibility of the touch window can be improved.

According to the first embodiment, the leakage of the resin layer may be suppressed or the cover substrate or the substrate may be prevented from being peeled off or broken. Otherwise, those appearance defects may occur when the touch window is flexed or folded. Accordingly, the touch window according to the first embodiment may have improved reliability.

Furthermore, as for the touch window according to the second embodiment, the electrode layer may be easily patterned. More specifically, the conductive layer including a conductive material such as a conductive polymer, and the non-conductive layer including a photosensitive film may be disposed on the substrate, and, then, the electrode layer may be patterned via the exposure and development processes.

Accordingly, since the etching and the peeling process are not required when patterning the electrode layer, the electrode layer can be easily patterned and, thus, the process efficiency can be improved.

Furthermore, as for the touch window according to the third embodiment, both the first electrode and the second electrode may be disposed on the same face of the substrate. That is, the second electrode may be formed by laminating the base layer which receives the second electrode therein or thereon, to the substrate. As a result, no separate electrode supporting member is required, and an adhesive layer for bonding such a supporting member is not required.

Thus, the touch window according to the third embodiment may reduce the overall thickness of the touch window.

In addition, the touch sensor according to the fourth embodiment may have reduction in the overall thickness of the touch sensor using the conductivity conversion member.

Furthermore, the touch sensor according to the fourth embodiment may omit a chip that converts an analog signal to a digital signal. In other words, a separate driver chip for converting an analog signal into a digital signal is not required, thereby simplifying a structure of the touch sensor. Furthermore, since the power used in the driver chip is not required, the electrical efficiency of the touch sensor may be improved.

### BRIEF DESCRIPTION OF THE DRAWINGS

FIG. 1 is a perspective view of the touch window according to the first embodiment.

FIG. 2 is a top view of the touch window according to the first embodiment.

FIG. 3 is a cross-sectional view of a region A-A′ of FIG. 2 according to the first embodiment.

FIGS. 4 to 6 are views for illustrating an electrode forming process for producing the sensing electrode and/or the wiring electrode according to the first embodiment.

FIG. 7 is a cross-sectional view of the touch window according to the second embodiment.

FIGS. 8 to 12 are views showing a manufacturing process of the touch window according to the second embodiment.

FIG. 13 is a cross-sectional view of the touch window according to the third embodiment.

FIGS. 14 through 17 are views showing a manufacturing process of the touch window according to the third embodiment.

FIGS. 18 to 21 are views showing an example of a touch device including the touch window according to each of the first, second, and third embodiments.

FIG. 22 is a perspective view of the touch sensor according to the fourth embodiment.

FIGS. 23 and 24 are cross-sectional views taken along a line A-A′ in FIG. 22 according to the fourth embodiment, and are views for illustrating electric connection between the first and second electrodes via the conductivity conversion member.

FIGS. 25 to 27 are another cross-sectional views taken along a line A-A′ in FIG. 22 according to the fourth embodiment.

FIG. 28 illustrates a touch device including the touch sensor according to the fourth embodiment.

FIGS. 29 to 32 illustrate a touch device including the touch sensor according to the fourth embodiment.

### DETAILED DESCRIPTIONS

In the description of embodiments, terms “on” and “under” may be interpreted as follows:

It is to be understood that when one layer (film), region, pattern or structure is disposed “on” or “under” another layer (film), region, pattern or structure, this may refer to not only a case where one layer (film), region, pattern or structure is directly disposed “on” or “under” another layer (film), region, pattern or structure, but also a case where a further layer (film), region, pattern or structure is disposed between one layer (film), region, pattern or structure and another layer (film), region, pattern or structure. The terms “on” and “under” may be employed with reference to the drawings.

It will be understood that when an element or layer is referred to as being “connected to”, or “coupled to” another element or layer, it can be directly on, connected to, or coupled to the other element or layer, or one or more intervening elements or layers may be present. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof.

For simplicity and clarity of illustration, in the drawings, a thickness or a size of a layer (film), region, pattern or structure may be modified. Thus, the layer (film), region, pattern or structure in the figures are not necessarily drawn to scale.

Hereinafter, embodiments of the present disclosure will be described in detail with reference to the accompanying drawings.

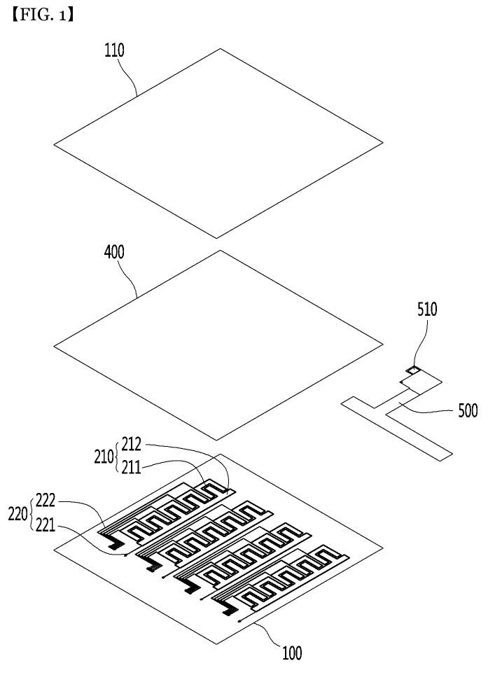

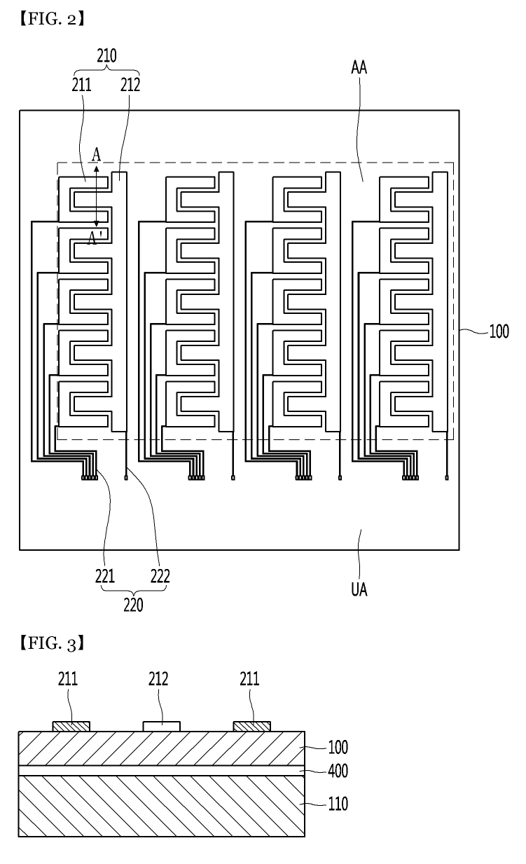

Referring to FIGS. 1 and 2, a touch window according to a first embodiment may include a cover substrate 110, a resin layer 400, a substrate 100, an electrode, and a printed circuit board 500.

The cover substrate 110 may support the resin layer 400, the substrate 100, the electrode, and the printed circuit board 500. That is, the cover substrate 110 may be a supporting substrate.

The cover substrate 110 may be rigid or flexible.

For example, the cover substrate 110 may comprise glass or plastic.

In detail, the cover substrate 110 may include a chemical reinforced/semi-reinforce glass such as soda lime glass or alpminosilicate glass, or may include reinforced or soft plastics such as polyimide (PI), polyethylene terephthalate (PET), propylene glycol (PPG), polycarbonate (PC) and the like, or may include sapphire.

Further, the cover substrate 110 may comprise an optically-isotropic film. In one example, the cover substrate 110 may include COC (cyclic olefin copolymer), COP (cyclic olefin polymer), optically-isotropic polycarbonate (PC) or optically-isotropic polymethylmethacrylate (PMMA).

Sapphire has excellent electrical properties such as dielectric constant, which can dramatically increase the touch response rate. In addition, sapphire can easily implement spatial touch such as hovering. In addition, sapphire has high surface strength and thus can be used as the cover substrate. In this connection, the term “hovering” refers to a technique of recognizing coordinates even at a small distance from a display surface.

Furthermore, the cover substrate 110 may have partially a curved face and thus be bent. That is, the cover substrate 110 partially has a planar face and partially has a curved face, and may thus be bent. In detail, an end of the cover substrate 110 has a curved face so that it can be bent. Alternatively, the cover substrate 110 may have a surface with random curvatures and thus may be bent or flexible.

Furthermore, the cover substrate 110 may be a flexible substrate having flexible properties.

Furthermore, the cover substrate 110 may be a curved, bent, or rollable substrate. That is, the touch window including the cover substrate 110 may have a flexible, curved, bent or rollable property. Accordingly, the touch window according to the embodiment is easy to carry and can be modified to have various designs.

The separate substrate 100 may be further disposed on the cover substrate 110. That is, a sensing electrode 210, a wiring electrode 220, and the printed circuit board 500 may be supported by the substrate 100. The substrate 100 and the cover substrate 110 may be bonded to each other via the resin layer 400.

The substrate 100 may be divided into an active area AA and an inactive area UA.

A display may be active in the active area AA and a display may not be active in the inactive area UA around the active area AA.

Furthermore, in at least one area of the active area AA and the inactive area UA, a location of an input device (e.g., a finger, etc.) thereon may be detected. When such an input device such as a finger is brought into contact with the touch window, a capacitance difference occurs at a contact portion of the input device. Thus, the portion with the capacitance difference may be detected as a contact position.

The substrate 100 may comprise the same material as or similar material to the cover substrate 110.

Furthermore, the substrate 100 may have partially a curved face and thus be bent. That is, the substrate 100 partially has a planar face and partially has a curved face, and may thus be bent. In detail, an end of the substrate 100 has a curved face so that it can be bent. Alternatively, the substrate 100 may have a surface with random curvatures and thus may be bent or flexible.

Furthermore, the substrate 100 may be a flexible substrate having flexible properties.

Furthermore, the substrate 100 may be a curved, bent, or rollable substrate. That is, the touch window including the substrate 100 may have a flexible, curved, bent or rollable property.

The electrode may be disposed on the substrate 100. For example, the electrode may be disposed on one face of the substrate 100. In detail, the electrode may be disposed in contact with one surface of the substrate 100.

The electrode may include the sensing electrode 210 and the wiring electrode 220. For example, the sensing electrode 210 may be disposed in direct contact with one face of the substrate 100. For example, the wiring electrode 220 may be disposed in direct contact with one face of the substrate 100.

The sensing electrode 210 may be disposed in at least one area of the active area AA and the inactive area UA of the substrate 100. In detail, the sensing electrode 210 may be disposed in the active area AA of the substrate 100.

The sensing electrode 210 may include a first sensing electrode 211 and a second sensing electrode 212.

The first sensing electrode 211 and the second sensing electrode 212 may be disposed on one face of the substrate 100. In detail, the first sensing electrode 211 and the second sensing electrode 212 may be disposed on the same face of the substrate 100. That is, the first sensing electrode 211 and the second sensing electrode 212 may be spaced apart from each other so that they do not contact each other on the same face of the substrate 100.

The sensing electrode 210 may include a transparent conductive material so that electrons may flow therein without interfering with transmission of light. In one example, the sensing electrode 210 is made of metal oxide such as indipm tin oxide, indipm zinc oxide, copper oxide, tin oxide, zinc oxide, titanipm oxide, and the like.

Alternatively, at least one of the first sensing electrode 211 and the second sensing electrode 212 may comprise a nanowire, a photosensitive nanowire film, a carbon nanotube (CNT), graphene, conductive polymer, or a mixture thereof.

When containing a nanocomposite such as a nanowire or a carbon nanotube (CNT) in the electrode, the electrode may be black. Further, by controlling the content of nanopowders, the color and reflectance of the electrode can be controlled while securing the electric conductivity.

Alternatively, the sensing electrode 210 may comprise various metals. For example, the sensing electrode 210 may include at least one of chromipm (Cr), nickel (Ni), copper (Cu), alpminpm (Al), silver (Ag), molybdenpm (Mo), gold (Au), titanipm (Ti), and alloys thereof.

The sensing electrode 210 may be formed in a mesh shape. In detail, the sensing electrode 210 may include a plurality of sub-electrodes, and the sub-electrodes may be arranged to intersect with each other in a mesh shape.

The sensing electrode 210 may have a mesh shape so that the sensing electrode pattern may not be visible in the active area, in one example, in the display area. That is, even when the sensing electrode 210 is formed of a metal, the electrode pattern may not be visible. Furthermore, the sensing electrode 210 may be applied to a larger size of the touch window to lower the resistance of the touch window.

The wiring electrode 220 may be connected to the sensing electrode 210. The wiring electrode 220 may be disposed in at least one of the active area AA and the inactive area UA of the substrate 100. In detail, the wiring electrode 220 may be disposed in both the active area AA and the inactive area UA of the substrate 100.

The wiring electrode 220 may extend in a direction from the active area AA to the inactive area UA of the substrate 100. The wiring electrode 220 may extend toward the inactive area UA of the substrate 100 and, in turn, be connected to the printed circuit board 500.

One end of the wiring electrode 220 may be connected to the sensing electrode 210, and the other end of the wiring electrode 220 may be connected to the printed circuit board 500.

The wiring electrode 220, the first sensing electrode 211, and the second sensing electrode 212 may be disposed on the same face of the substrate 100.

The wiring electrode 220 may include a first wiring electrode 221 and a second wiring electrode 222. For example, the wiring electrode 220 may include the first wiring electrode 221 connected to the first sensing electrode 211, and the second wiring electrode 222 connected to the second sensing electrode 212.

The wiring electrode 220 may include a conductive material. In one example, the wiring electrode 220 may comprise the same or similar material as or to the sensing electrode 210 described above.

The wiring electrode 220 receives a touch signal sensed by the sensing electrode 210, and the touch signal is then transmitted a driver chip 510 mounted on the printed circuit board 500, which is electrically connected to the sensing electrode 210 via the wiring electrode 220.

The printed circuit board 500 may be a flexible printed circuit board (FPCB). The printed circuit board 500 may be connected to the wiring electrode 220 disposed in the inactive area UA. In detail, the printed circuit board 500 may be connected to the wiring electrode 220 via an anisotropic conductive film ACF or the like in the inactive area UA.

The driver chip 510 may be mounted on the printed circuit board 500. In detail, the driver chip 510 may receive the touch signal sensed by the sensing electrode 210 via the wiring electrode 220, and, in turn, may perform an operation based on the touch signal.

The wiring electrode 220 may be formed in a mesh shape like the sensing electrode 210.

Referring to FIG. 3, the resin layer 400 may be disposed on the cover substrate 110, and the substrate 100 may be disposed on the resin layer 400.

The resin layer 400 may be disposed between the cover substrate 110 and the substrate 100. That is, the resin layer 400 may be an intermediate layer disposed between the cover substrate 110 and the substrate 100.

One face of the resin layer 400 may contact the cover substrate 110. The other face of the resin layer 400 opposite to said one face where the resin layer 400 and the cover substrate 110 contact each other may contact the substrate 100.

The resin layer 400 may comprise an adhesive material. That is, the resin layer 400 may be an adhesive layer. For example, the resin layer 400 may be a transparent adhesive layer. In detail, the resin layer 400 may comprise an optical material.

The resin layer 400 may include at least one of a photo-curable resin and a thermosetting resin.

For example, the resin layer 400 may include at least one of an acrylic-based resin composition, a urethane-based resin composition, and a silicon-based resin composition.

The cover substrate 110 and the substrate 100 may be bonded to each other via the resin layer 400.

A thickness, modulus, adhesion and viscosity of the resin layer 400 may be determined so as to prevent deformation of the substrate and/or the cover substrate or deformation of the resin layer using tensile and compression tests.

The applicants also measured the deformation of the substrate and/or the cover substrate or the deformation of the resin layer when the touch window was flexed repeatedly using a rollable machine.

The resin layer 400 may be disposed over the entire face of the cover substrate 110.

The resin layer 400 may be disposed at a thickness of about 1 μm to about 10 μm. For example, the resin layer 400 may be disposed at a thickness of about 1 μm to about 7 μm. More preferably, the resin layer 400 may be disposed at a thickness of about 1 μm to about 5 μm.

When the resin layer 400 is disposed at a thickness of about 1 μm to about 10 μm, an overall thickness of the touch window may be thinned and the flexibility of the touch window including the resin layer 400 may be improved.

This may prevent deformation of the resin layer that may otherwise occur when the touch window is bent or folded. In detail, the resin layer 400 may be prevented from leaking out of the cover substrate 110 or the substrate 100 at outer edges thereof. Further, it is possible to prevent the cover substrate 110 or the substrate 100 from being peeled off or broken, which may otherwise occur due to the reduced flexibility of the resin layer 400.

When the resin layer 40 has a thickness greater than about 10 μm, the thickness of the touch window may be increased due to the resin layer 400, and, thus, the flexibility of the touch window may be reduced.

The resin layer 400 may have a modulus of 1.5×105 Pa to 3.0×105 Pa. For example, the modulus of the resin layer 400 may be in a range of 2.0×105 Pa to 3.0×105 Pa. More specifically, the modulus of the resin layer 400 may be in a range of 2.5×105 Pa to 3.0×105 Pa.

The term “modulus” is a modulus of elasticity that represents a ratio between stress and strain. It may be used as a measure of a material's hardness or ductility.

When the modulus of the resin layer 400 is in the range of 1.5×105 Pa to 3.0×105 Pa, the deformation of the touch window due to stress may be reduced. For example, it is possible to prevent deformation of the resin layer 400 due to stress or deformation of the cover substrate 110 or the substrate 100 due to the stress. As a result, the reliability of the touch window including the resin layer 400 may be improved.

In detail, when the modulus of the resin layer 400 is in the range of 1.5×105 Pa to 3.0×105 Pa, a stress at an adhesive interface between the cover substrate 110 and the resin layer 400 or a stress at an adhesive interface between the substrate 100 and the resin layer 400 may be reduced. Furthermore, the residual stress inside the resin layer 400 may decrease.

Accordingly, it is possible to prevent the cover substrate 110 and/or the substrate 100 from being peeled off or damaged.

When the modulus of the resin layer 400 exceeds 3.0×105 Pa, the reliability of the touch window may be lowered due to deformation of the touch window due to stress.

The resin layer 400 may have an adhesion of about 10 N/cm or larger. For example, the resin layer 400 may have an adhesion of about 10 N/cm to about 30 N/cm. More specifically, the resin layer 400 may have an adhesion of about 10 N/cm to about 20 N/cm.

When the resin layer 400 has an adhesion of about 10 N/cm or larger, it may prevent deformation of the resin layer 400 due to stress or deformation of the cover substrate 110 or the substrate 100 due to the stress. As a result, the reliability of the touch window including the resin layer 400 may be improved.

More specifically, when the resin layer 400 has an adhesion of about 10 N/cm or larger, a bonding strength at an adhesive interface between the cover substrate 110 and the resin layer 400, or at an adhesive interface between the substrate 100 and the resin layer 400 may increase. Accordingly, it is possible to prevent the cover substrate 110 and/or the substrate 100 from being peeled off, or damaged.

When the adhesion of the resin layer 400 is smaller than about 10 N/cm, the reliability of the touch window may be degraded due to the deformation of the touch window due to stress.

The resin layer 400 may have a viscosity of about 1000 cps to about 2000 cps. For example, the resin layer 400 may have a viscosity of about 1500 cps to about 2000 cps.

When the resin layer 400 has a viscosity of about 1000 cps to about 2000 cps, the resin layer 400 may be thinly deposited at a thickness of about 1 μm to about 10 μm. Thus, the flexibility of the touch window may also be improved.

Further, this may allow the resin layer 400 to be uniformly disposed over the cover substrate 110, and, thus, the process efficiency may be improved.

Furthermore, this may prevent the resin layer from deforming, which may otherwise occur when the touch window is bent or folded. For example, this may prevent the resin layer 400 from leaking out of the cover substrate 110 or the substrate 100 at an outer edge thereof. Further, this may prevent deformation such as pressing of the resin layer 400 due to an external impact.

When the viscosity of the resin layer 400 exceeds about 2000 cps, the process efficiency may be lowered or the thickness of the resin layer may become larger.

When the viscosity of the resin layer 400 is smaller than about 1000 cps, a leakage of the resin layer 400 may occur.

The substrate 100 may be disposed on the resin layer 400. The substrate 100 may be disposed on the entire face of the resin layer 400.

The substrate 100 may be disposed at a thickness of about 30 μm to about 70 μm. For example, the substrate 100 may be disposed at a thickness of about 30 μm to about 60 μm. More specifically, the substrate 100 may be disposed at a thickness of about 30 μm to about 50 μm.

When the substrate 100 is disposed at a thickness of about 30 μm to about 70 μm, the overall thickness of the touch window may be reduced. Accordingly, the flexible, curved, bendable, or rollable property of the touch window including the substrate 100 may be improved.

One face of the resin layer 400 may include a curved surface. For example, the resin layer 400 may be bent with a partially curved face. That is, the resin layer 400 may be partially flat and partially curved, so that the resin layer 400 may be bent. More specifically, one end of the resin layer 400 may be curved to be bent. Alternatively, the resin layer 110 may have a surface with random curvatures and thus may be bent or flexible.

For example, the resin layer 400 may be entirely curved to be bent.

FIGS. 4 to 6 are views for illustrating an electrode forming process for forming the sensing electrode and/or the wiring electrode according to the first embodiment.

Referring to FIG. 4, the sensing electrode and/or the wiring electrode according to the first embodiment may be formed by disposing a metal layer M on an entire face of the substrate 100 and etching the metal layer M into a mesh shape. The mesh-shaped electrode may be formed. For example, the metal layer M such as a copper Cu layer may be deposited on an entire face of the substrate 100 such as poly(ethylene terephthalate) (PET) substrate. Then, the copper layer may be etched to form an embossed mesh-shaped copper electrode. The metal layer M may comprise the electrode.

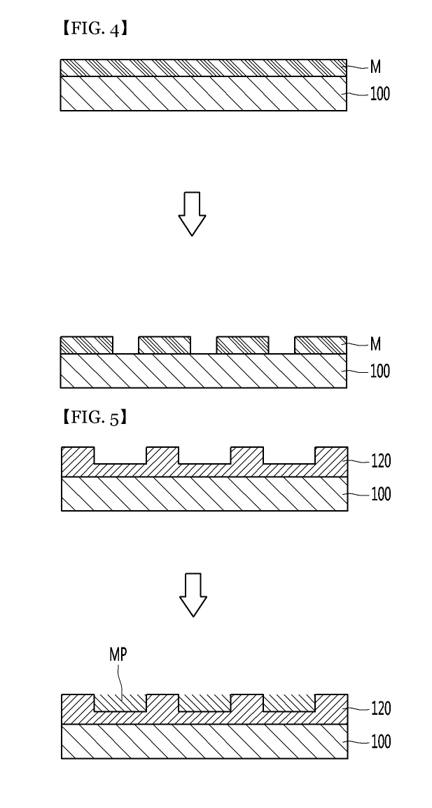

In an alternative, referring to FIG. 5, the sensing electrode and/or the wiring electrode according to the first embodiment may be formed as follows. A second resin layer 120 including a UV resin layer or a thermosetting resin layer may be formed on the substrate 100, and then a mesh-shaped engraved pattern P may be formed in the second resin layer 120. Then, the mesh-shaped engraved pattern P may be filled with a metal paste MP. In this connection, the engraved pattern in the second resin layer may be formed by imprinting a mold having an embossed pattern corresponding thereto.

The metal paste MP may contain at least one metal selected from a group consisting of chromipm (Cr), nickel (Ni), copper (Cu), alpminpm (Al), silver (Ag), molybdenpm (Mo), gold (Au), titanipm (Ti) and alloys thereof. Accordingly, the metallic mesh-shaped engraved-type electrode pattern may be formed by filling the metal paste into the mesh-shaped engraved pattern and curing the metal paste. The cured metal paste may include the electrode.

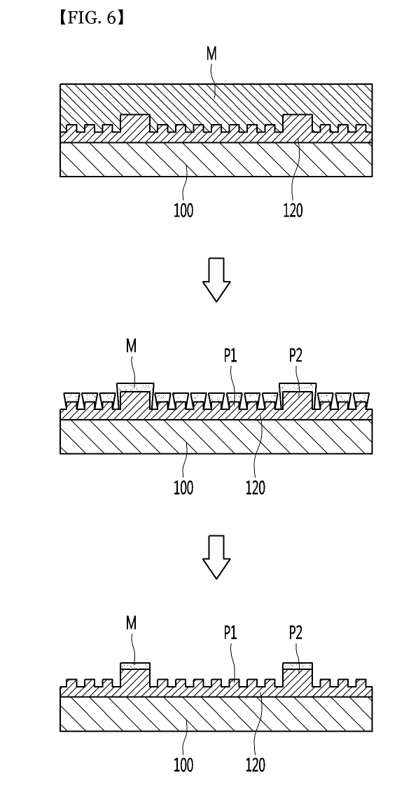

Alternatively, referring to FIG. 6, the sensing electrode and/or the wiring electrode according to the first embodiment may be formed as follows. On the substrate 100, a second resin layer may be formed that includes a UV resin layer or a thermosetting resin layer. Mesh-shaped embossed nano-pattern and micro-pattern P1 and P2 may be formed on the second resin layer 120. Then, at least one metal M selected from a group consisting of chromipm (Cr), nickel (Ni), copper (Cu), alpminpm (Al), silver (Ag), molybdenpm (Mo) and alloys thereof may be sputtered onto the resin layer.

In this connection, the mesh-shaped embossed nano-pattern and micro-pattern P1 and P2 may be formed by imprinting a mold having an engraved pattern corresponding thereto.

Then, the metal layer formed on the nano-pattern and the micro-pattern P1 and p2 may be etched. In this connection, the mesh-shaped metal electrode may be formed by removing only the metal layer formed on the nano-pattern P1 and leaving only the metal layer formed on the micro-pattern P2.

In this connection, when the metal layer M is etched, a difference in etching rate may occur depending on a difference between a first junction area between the nano pattern P1 and the metal layer M, and a second junction area between the micro-pattern P2 and the metal layer M. That is, since the second junction area between the micro-pattern P2 and the metal layer M is larger than the first junction area between the nano-pattern P1 and the metal layer M, the etching of the electrode material formed on the micro-pattern P2 occurs less, while the etching of the electrode material formed on the nano-pattern P1 occurs more. Accordingly, the metal layer M formed on the micro-pattern P2 remains and the metal layer formed on the nano-pattern P1 is etched and removed. Thus, the mesh-shaped metal electrode with the embossed micro-pattern may be formed on the substrate 100. The electrode material may comprise the electrode.

Hereinafter, the first embodiment of the present disclosure will be described in more detail with reference to the present examples and comparison examples. These present examples are merely illustrative of the first embodiment in more detail. Accordingly, the first embodiment is not limited to these present examples.

### The Present Example 1

A resin layer is disposed on a cover substrate. A substrate is disposed on the resin layer, and an electrode is disposed on the substrate, thereby forming a touch window.

In this connection, a modulus of the resin layer was 2.1×10⁵ Pa, an adhesion of the resin layer was 10.8 N/cm, and a viscosity of the resin layer was 1700 cps.

Then, using a rollable machine, whether the cover substrate or the substrate was peeled off, and whether the resin layer was deformed or not were determined.

### The Present Example 2

A resin layer is disposed on a cover substrate. A substrate is disposed on the resin layer, and an electrode is disposed on the substrate, thereby forming a touch window. In this connection, a modulus of the resin layer was 2.6×10⁵ Pa, an adhesion of the resin layer was 12.1 N/cm, and a viscosity of the resin layer was 1900 cps. Then, using a rollable machine, whether the cover substrate or the substrate was peeled off, and whether the resin layer was deformed or not were determined.

### The Present Example 3

A resin layer is disposed on a cover substrate. A substrate is disposed on the resin layer, and an electrode is disposed on the substrate, thereby forming a touch window. In this connection, a modulus of the resin layer was 2.8×10⁵ Pa, an adhesion of the resin layer was 15.4 N/cm, and a viscosity of the resin layer was 1600 cps. Then, using a rollable machine, whether the cover substrate or the substrate was peeled off, and whether the resin layer was deformed or not were determined.

### Comparison Example 1

A resin layer is disposed on a cover substrate. A substrate is disposed on the resin layer, and an electrode is disposed on the substrate, thereby forming a touch window. In this connection, a modulus of the resin layer was 6.8×10⁵ Pa, an adhesion of the resin layer was 5.2 N/cm, and a viscosity of the resin layer was 3600 cps. Then, using a rollable machine, whether the cover substrate or the substrate was peeled off, and whether the resin layer was deformed or not were determined.

### Comparison Example 2

A resin layer is disposed on a cover substrate. A substrate is disposed on the resin layer, and an electrode is disposed on the substrate, thereby forming a touch window. In this connection, a modulus of the resin layer was 1.7×10⁵ Pa, an adhesion of the resin layer was 8.3 N/cm, and a viscosity of the resin layer was 2500 cps. Then, using a rollable machine, whether the cover substrate or the substrate was peeled off, and whether the resin layer was deformed or not were determined.

TABLE 1

| | Was the cover substrate or the |
|---|---|
| Examples | substrate peeled off? |
| The present example 1 | No |
| The present example 2 | No |
| The present example 3 | No |
| Comparison example 1 | Yes |
| Comparison example 2 | Yes |

TABLE 2

| Examples | Does the resin layer leak? |
|---|---|
| The present example 1 | No |
| The present example 2 | No |
| The present example 3 | No |
| Comparison example 1 | Yes |
| Comparison example 2 | Yes |

Referring to Table 1 and Table 2, the followings may be observed. First, when the modulus of the resin layer is in the range of 2.0×10⁵ Pa to 3.0×10⁵ Pa, the deformation of the touch window due to stress may be reduced. That is, using the rollable machine, the cover substrate or the substrate was not peeled off.

Furthermore, it may be seen that the bonding strength between the cover substrate and the resin layer or between the substrate and the resin layer is excellent when the adhesion of the resin layer is 10 N/cm or more. In other words, it may be seen that the adhesion between the cover substrate and the resin layer or between the substrate and the resin layer is improved, so that the cover substrate or the substrate is not peeled off or broken.

Moreover, it may also be seen that the resin layer does not leak when the viscosity of the resin layer is between 1500 cps and 2000 cps.

That is, the touch window according to the first embodiment may be formed by disposing the resin layer on the cover substrate, disposing the substrate on the resin layer, and disposing the electrode on the substrate. In this connection, the resin layer 400 is disposed at a thickness of about 1 μm to about 10 μm. Thus, the overall thickness of the touch window may be reduced. This can improve reliability of the touch window when implementing the flexible touch window.

Hereinafter, a touch window according to a second embodiment of the present disclosure will be described with reference to FIGS. 7 to 12. FIG. Duplicate descriptions to the first embodiment described above may be omitted. The same reference numerals are assigned to the same components.

Referring to FIG. 7, the touch window according to the second embodiment may include a substrate 100 and an electrode layer 200.

The electrode layer 200 may be disposed on the substrate 100. The electrode layer 200 may include at least one electrode of a sensing electrode and a wiring electrode. For example, the electrode layer 200 may include the sensing electrode disposed in an active area and a wiring electrode disposed in a inactive area.

The electrode layer 200 may be formed of at least two layers. Referring to FIG. 7, the electrode layer 200 may be formed of a first layer and a second layer.

The electrode layer 200 may include a non-conductive layer 201 and a conductive layer 202. For example, the electrode layer 200 may include a non-conductive layer 201 on the substrate 100 and a conductive layer 202 on the non-conductive layer 201. More specifically, the conductive layer 202, which is the second layer, may be disposed on the non-conductive layer 201 that is the first layer. Accordingly, the lower surface of the non-conductive layer 201 is in contact with the substrate 100, and the upper surface of the non-conductive layer 201 is in contact with the conductive layer 202.

The non-conductive layer 201 may include a photosensitive material. For example, the non-conductive layer 201 may include a photosensitive film.

In addition, the conductive layer 202 may comprise a variety of metals. For example, the conductive layer 202 may contain at least one of chromipm (Cr), nickel (Ni), copper (Cu), alpminpm (Al), silver (Ag), molybdenpm (Mo), gold (Au), titanipm (Ti), and alloys thereof.

Further, the conductive layer 202 may be formed in a mesh shape. More specifically, the conductive layer 202 may include a plurality of sub-electrodes, and the sub-electrodes may be arranged to intersect with each other in a mesh shape.

More specifically, the conductive layer 202 may include a plurality of mesh lines defined by the plurality of sub-electrodes crossing each other in a mesh shape, and a plurality of mesh openings defined between the mesh lines.

A line width of each of the mesh lines may be in a range of about 0.1 μm to about 10 μm. When the line width of each of the mesh lines is smaller than about 0.1 μm, formation of the mesh line portion with such a line width may be impossible due to a manufacturing process, or, if possible, short-circuiting of the mesh line may occur. When the line width of the mesh line is larger than about 10 μm, the electrode pattern may be visually recognized. Preferably, the linewidth of the mesh wire may be between about 0.5 microns and about 7 microns. More preferably, the line width of the mesh line may be between about 1 μm and about 3.5 μm.

Further, each of the mesh openings may be formed in various shapes. For example, the mesh opening may have various shapes such as a square shape, a diamond shape, a pentagonal shape, a hexagonal shape, or a circular shape. Further, the mesh openings may be arranged in a regular shape or a random shape.

The conductive layer 202 may have a mesh shape so that the pattern of the sensing electrode may not be visible in the active area, in one example, a display area. That is, even when the sensing electrode is formed of a metal, the pattern may not be visible. In addition, the sensing electrode may be applied to the touch window of a larger size to lower the resistance of the touch window.

For example, the conductive layer 202 may include a conductive polymer. For example, the conductive layer 202 may comprise at least one conductive polymer material selected from a group consisting of poly 3,4-ethylenedioxythiophene, polyaniline, polyphenylenevinylene, polythienylenevinylene, polyacetylene, polypyrrole, polythiophene, poly(3-alkylthiophene), polyphenlyenevinylene, polythienyl-enevinylene, polyphenylene, polyisothianaphthene, polyazulene and polyfuran.

The non-conductive layer 201 and the conductive layer 202 may be disposed in direct or indirect contact with each other. For example, the lower surface of the conductive layer 202 may be disposed in contact with the upper surface of the non-conductive layer 201. In addition, the non-conductive layer 201 and the conductive layer 202 may have a width corresponding to each other, and they may be disposed on the substrate 100. Further, the non-conductive layer 201 and the conductive layer 202 may have the same thickness or different thicknesses.

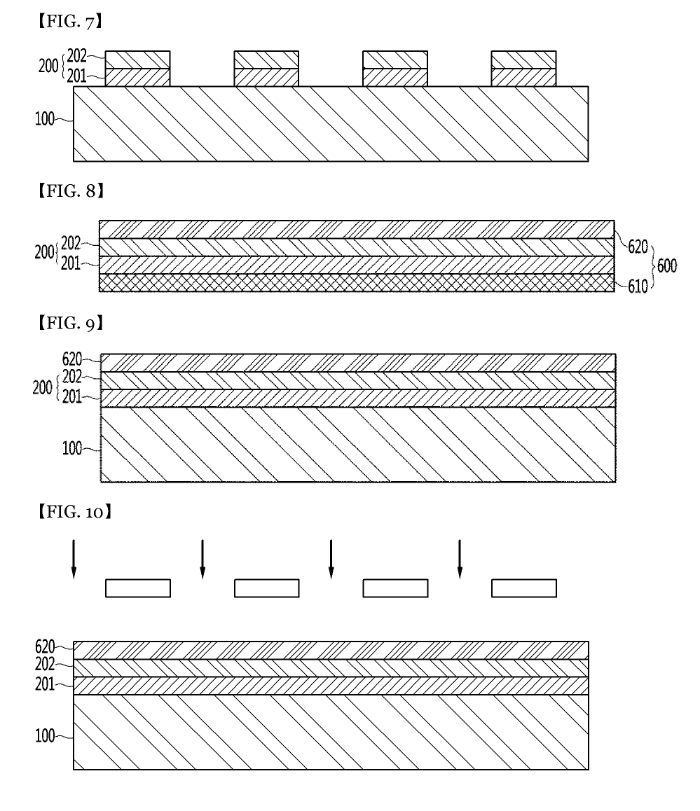

Hereinafter, a manufacturing process of the touch window according to the second embodiment will be described with reference to FIGS. 8 to 12.

Referring to FIG. 8, an electrode layer 200 including a non-conductive layer 201 and a conductive layer 202 is prepared. Each release layer 600 may be disposed on each of opposing both faces of the electrode layer to protect the non-conductive layer 201 and the conductive layer 202.

More specifically, a first release layer 610 may be disposed on a bottom face of the non-conductive layer 201, and a second release layer 620 may be disposed on a top face of the conductive layer 202.

Referring to FIG. 9, the first release layer 610 may be removed, and the electrode layer 200 may be disposed on the substrate 100. More specifically, the electrode layer 200 may be disposed on the substrate 100 such that the non-conductive layer 201 contacts the substrate 100 directly or indirectly.

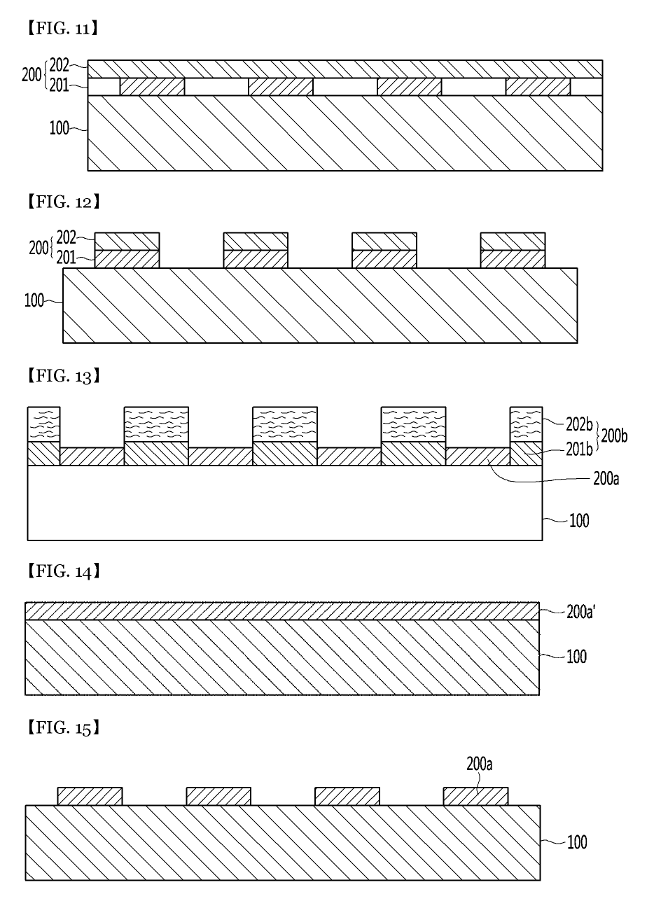

Subsequently, referring to FIG. 10, a mask may be disposed on the electrode layer 200. Then, an exposure process may be performed by irradiating ultraviolet light or the like thereto. For example, while the mask is disposed in a region in which the electrode is to be formed, and the mask is not disposed in a region in which the electrode is not to be formed, the exposure process may be performed.

Referring to FIG. 11, after the second release layer 620 disposed on the electrode layer 200 is removed, the development process may be performed on the electrode layer 200. Thus, as shown in FIG. 12, the non-conductive layer 201 and the conductive layer 202 in a region where the mask is not disposed are removed, while the non-conductive layer 201 and the conductive layer 202 in a region where the mask is disposed are left. In this way, the electrode layer 200 may be patterned.

As for the touch window according to the second embodiment, the electrode layer may be easily patterned. More specifically, the conductive layer including a conductive material such as a conductive polymer, and the non-conductive layer including a photosensitive film may be disposed on the substrate, and, then, the electrode layer may be patterned via the exposure and development processes.

Accordingly, since the etching and the peeling process are not required when patterning the electrode layer, the electrode layer may be easily patterned and the process efficiency may be improved.

Hereinafter, a touch window according to a third embodiment will be described with reference to FIGS. 13 to 17. Duplicate descriptions to the first embodiment described above may be omitted. The same reference numerals are assigned to the same components.

Referring to FIG. 13, the touch window according to the third embodiment may include a substrate 100, a first electrode 200a, and an electrode part 200b.

The substrate 100 may comprise the same or similar material as or to that of the substrate of the first embodiment described above.

The first electrode 200a may be partially disposed on the substrate 100. The first electrode 200a may comprise the same or similar material as or to that of the conductive layer 202 of the second embodiment described above.

For example, the first electrode 200a may include a conductive polymer.

The electrode part 200b may be partially disposed on the substrate 100. The electrode part 200b may include a base layer 201b and a second electrode 202b. For example, the electrode part 200b may include the base layer 201b on the substrate 100 and the second electrode 202b on the base layer 201b.

The base layer 201b may be disposed in contact with at least one of the substrate 100 and the first electrode 200a. The base layer 201b may be directly disposed on the substrate 100. The substrate 100 and the base layer 201b may be laminated.

The base layer 201b may include a non-conductive material. For example, the base layer 201b may include a photosensitive material. More specifically, the base layer 201b may include a photosensitive film.

The second electrode 202b may be disposed on the base layer 201b. For example, the second electrode 202b may be disposed in the base layer 201b. More specifically, the second electrode 202b may be received within the base layer 201b. As shown in FIG. 13, the second electrode 202b is disposed on the base layer 201b. However, the present embodiment is not limited thereto. The second electrode 202b may be disposed in an upper, lower, and/or middle portion of the base layer 201b.

The second electrode 202b may include a material different from the first electrode 200a. In one example, the second electrode 202b may comprise nanowires. For example, the second electrode 202b may comprise metal nanowires. In one example, the second electrode 202b may include silver (Ag) nanowires.

The second electrode 202b and the first electrode 200a may be disposed on the same face of the substrate 100 as shown in FIG. 13.

The second electrode 202b and the first electrode 200a may be disposed on different regions. For example, the second electrode 202b and the first electrode 200a may be alternated with each other. More specifically, the first electrode 200a may include a plurality of patterns, and each second electrode 202b may be disposed in each space between adjacent patterns of the first electrode 200a.

Meanwhile, the top surface of the second electrode 202b may have a different height from the top surface of the first electrode 200a.

For example, the first electrode 200a may be disposed in direct contact with the substrate 100. The second electrode 202b may be disposed in direct contact with the base layer 201b contacting the substrate 100. Depending on the thickness of the base layer 201b, the top surface of the second electrode 202b may be higher than the top surface of the first electrode 200a.

The second electrode 202b may extend in one direction. For example, the first electrode 200a and the second electrode 202b may extend in different directions. More specifically, the first electrode 200a may extend in a first direction and the second electrode 202b may extend in a second direction different from the first direction.

Each of the first electrode 200a and the second electrode 202b may include at least one of a sensing electrode and a wiring electrode. Furthermore, each of the sensing electrode and the wiring electrode may be arranged in a mesh shape.

Hereinafter, a manufacturing process of the touch window according to the third embodiment will be described with reference to FIGS. 14 to 17.

Referring to FIG. 14, a first electrode forming material 200a′ may be disposed on the substrate 100. FIG. The first electrode forming material 200a′ may include a conductive polymer. For example, the first electrode forming material 200a′ may include at least one conductive polymer material selected from a group consisting of poly 3,4-ethylenedioxythiophene, polyaniline, polyphenylenevinylene, polythienylenevinylene, polyacetylene, polypyrrole, polythiophene, poly(3-alkylthiophene), polyphenlyenevinylene, polythienyl-enevinylene, polyphenylene, polyisothianaphthene, polyazulene and polyfuran.

Referring to FIG. 15, the first electrode 200a may be patterned. For example, the first electrode 200a may be patterned to extend in one direction. In one example, a mask may be arranged after a photosensitive material is applied on the first electrode. Then, the first electrode 200a may be patterned via exposure, development, and etching processes.

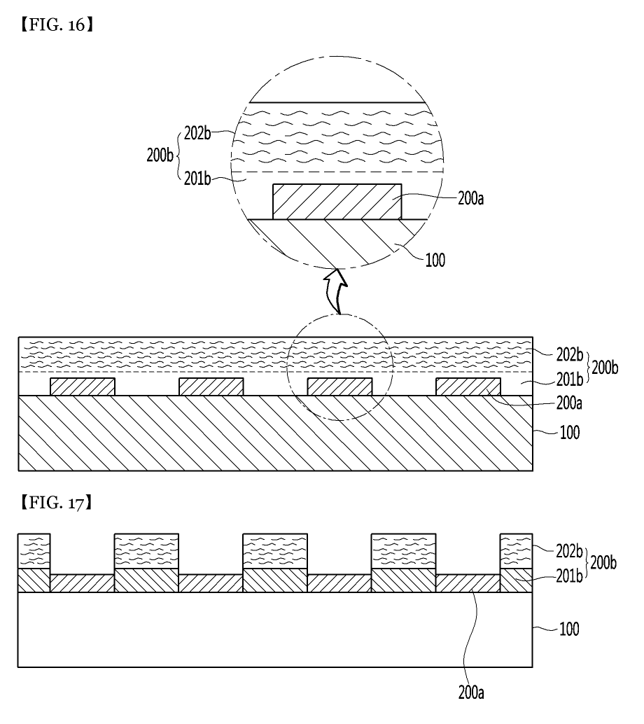

Referring to FIG. 16, the electrode part 200b may be disposed on the substrate 100. For example, the electrode part 200b may be formed such that the base layer 201b is laminated on the substrate 100.

The base layer 201b may surround the first electrode 200a. For example, the base layer 201b may be disposed in contact with the substrate 100 and the first electrode 200a.

The second electrode 202b may be disposed on the base layer 201b. For example, a second electrode 202b including nanowires may be disposed on the base layer 201b.

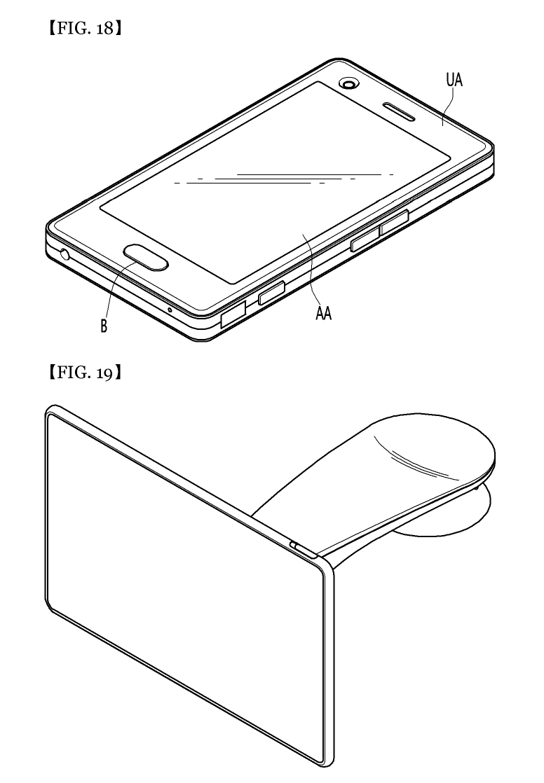

Referring to FIG. 17, after a mask is disposed, the electrode part 200b may be patterned by irradiating ultraviolet rays or the like thereto to perform the exposure process and then by developing the exposed process. That is, the base layer 201b and the second electrode 202b may be patterned.

For example, the base layer 201b and the second electrode 202b may be patterned to extend in a direction different from an extension direction of the first electrode 200a.

The touch window according to the third embodiment may have both the first electrode and the second electrode on the same face of the substrate. That is, the second electrode may be formed by laminating the base layer which receives the second electrode therein or thereon, to the substrate. As a result, no separate electrode supporting member is required, and an adhesive layer for bonding such a supporting member is not required.

Thus, the touch window according to the third embodiment may reduce the overall thickness of the touch window.

That is, all of the touch windows according to the first, second, and third embodiments may have the reduced thickness and thus have improved flexibility.

Hereinafter, an example of a touch device including each of the touch windows according to the first, second, and third embodiments described above will be described with reference to FIGS. 18 to 21.

Referring to FIG. 18, as one example of the touch device, a mobile device is shown. The mobile device may include an active area AA and a inactive area UA. The active area AA senses a touch signal by touching a finger or the like, and the inactive area includes a command icon, a logo, and a button B for performing operations such as on-off operation.

Referring to FIG. 19, the touch window may be applied not only to the touch device such as the mobile device but also to a car navigation system.

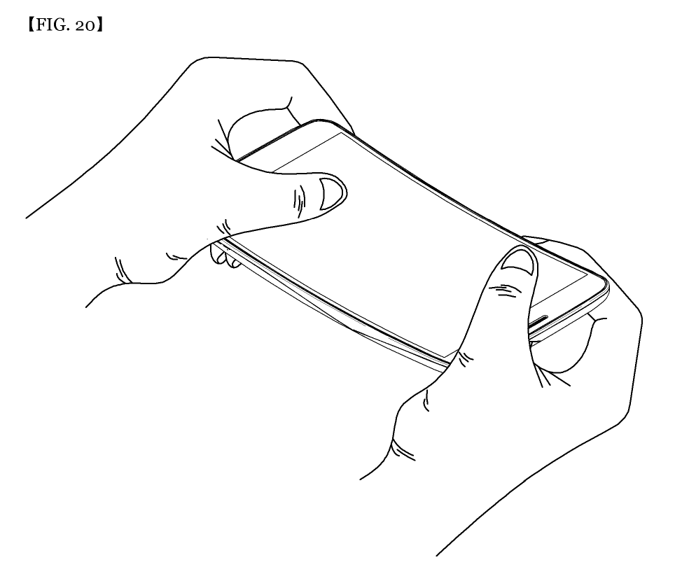

Referring to FIG. 20, the touch window may include a flexible touch window. Accordingly, the touch device including the flexible touch window may be embodied as a flexible touch device. Therefore, the user may bend or flex the touch device by hand. Such a flexible touch window may be applied to a wearable device or the like.

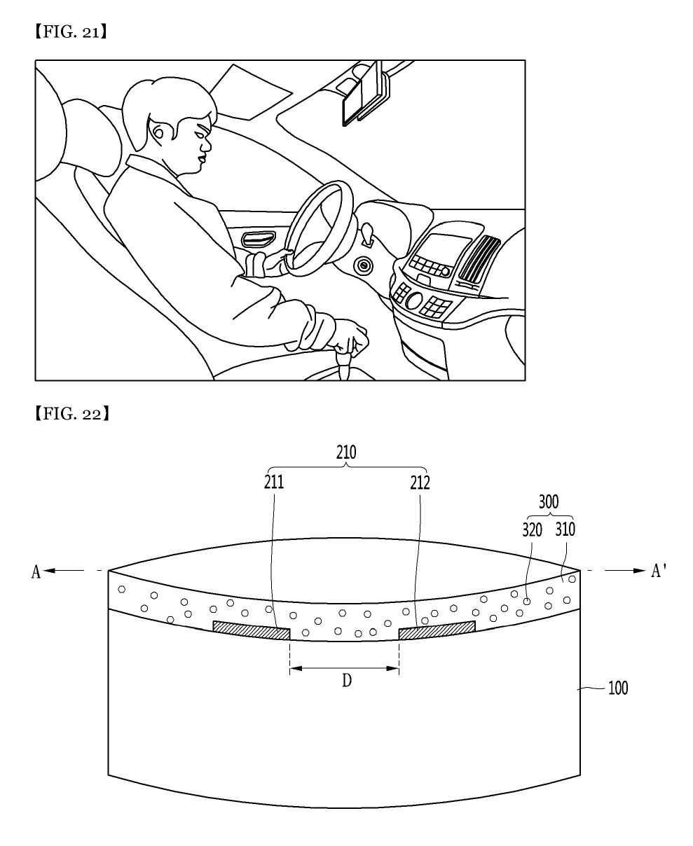

Furthermore, referring to FIG. 21, the touch window may also be applied to a vehicle. That is, the touch window may be applied to various parts of the vehicle. Therefore, not only PND (Personal Navigation Display) but also CID (Center Information Display) may be implemented by the present touch device being applied to a vehicle dashboard. However, the present disclosure is not limited thereto. It goes without saying that such a touch device may be applied to various electronic products.

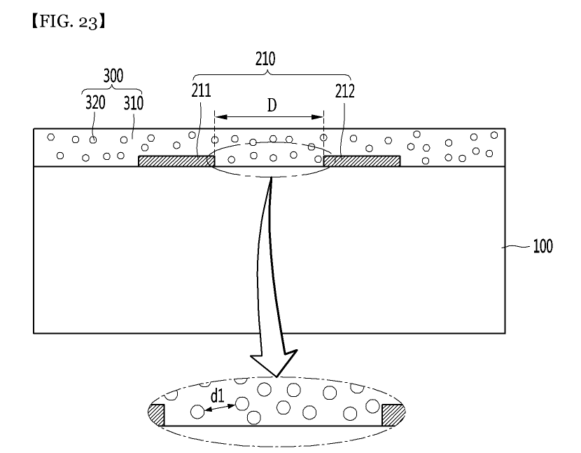

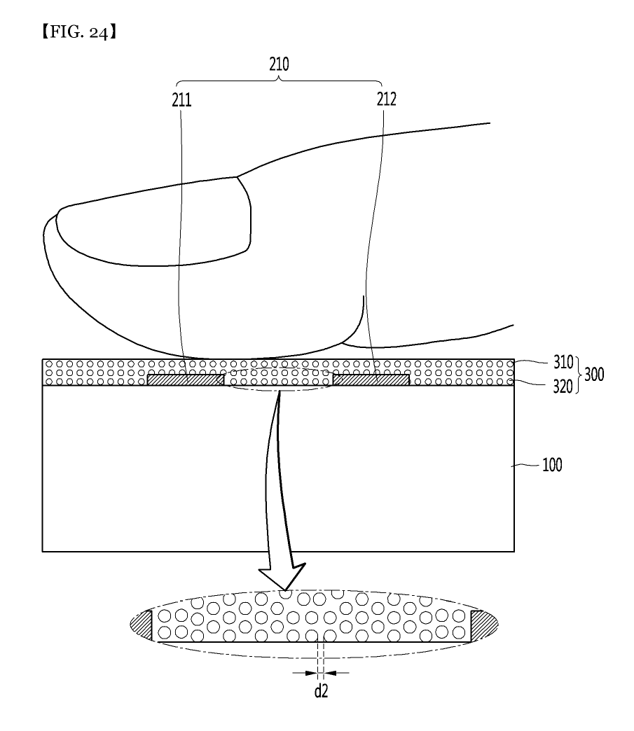

Hereinafter, a touch sensor according to a fourth embodiment will be described with reference to FIGS. 22 to 27. Duplicate descriptions to the first embodiment described above may be omitted. The same reference numerals are assigned to the same components.

FIGS. 22 to 27 are views showing the touch sensor according to the fourth embodiment. Referring to FIG. 22, the touch sensor according to the fourth embodiment may include a substrate 100, a sensing electrode 210, and a conductivity conversion member 300.

The sensing electrode 210 and the conductivity conversion member 300 may be disposed on the substrate 100. That is, the substrate 100 may be the supporting substrate.

The sensing electrode 210 may be disposed on the substrate 100. More specifically, the sensing electrode 210 may be disposed on one face of the substrate 100.

The sensing electrode 210 may include a first sensing electrode 211 and a second sensing electrode 212. More specifically, the first sensing electrode 211 and the second sensing electrode 212 may be disposed on the same face of the substrate 100.

The first sensing electrode 211 may be spaced apart from the second sensing electrode 212. The first sensing electrode 211 may be spaced apart from the second sensing electrode 212 by a predetermined distance D.

The first sensing electrode 211 and/or the second sensing electrode 212 may include a transparent conductive material to allow electricity to flow therein without interfering with the transmission of light therethrough.

In one example, the sensing electrode 210 includes a metal oxide such as indipm tin oxide, indipm zinc oxide, copper oxide, tin oxide, zinc oxide, and titanipm oxide.

Alternatively, at least one of the first sensing electrode 211 and the second sensing electrode 212 may comprise a semitransparent or opaque material.

For example, at least one of the first sensing electrode 211 and the second sensing electrode 212 may include nanowire, a photosensitive nanowire film, a carbon nanotube (CNT), graphene, conductive polymer, and/or a mixture thereof.

When containing a nanocomposite such as a nanowire or a carbon nanotube (CNT) in the electrode, the electrode may be black. Further, by controlling the content of nanopowders, the color and reflectance of the electrode can be controlled while securing the electric conductivity.

Alternatively, at least one of the first sensing electrode 211 and the second sensing electrode 212 may include various metals. For example, at least one of the first sensing electrode 211 and the second sensing electrode 212 may include at least one of chromipm (Cr), nickel (Ni), copper (Cu), alpminpm (Al), silver (Ag), molybdenpm (Mo), gold (Au), titanipm (Ti), and alloys thereof.

In one example, the first sensing electrode 211 and the second sensing electrode 212 may comprise a metal.

The conductivity conversion member 300 may be disposed on the substrate 100. More specifically, the conductivity conversion member 300 may be disposed on the substrate 100, and may surround the sensing electrode 210 on the substrate 100.

The conductivity conversion member 300 may include a matrix 310 and conductive particles 320. More specifically, the conductivity conversion member 300 may comprise the matrix 310 and the conductive particles 320 dispersed within the matrix 310.

The matrix 310 may surround the conductive particles 320. That is, the matrix 310 may have the conductive particles 320 dispersed therein. The matrix 310 may comprise a resin. Furthermore, the matrix 310 may be transparent, translucent or opaque.

The matrix 310 may include a thermosetting resin or a photo-curable resin. For example, the matrix 310 may include at least one of an epoxy-based resin, an acrylic-based resin, a polyimide-based resin, and a silicon-based resin.

Furthermore, the matrix 310 may include an elastic material. In one example, the elastic material may be received in the matrix 310. Alternatively, the elastic material may be disposed on the outer surface of the matrix.

The conductive particles 320 may be dispersed within the matrix 310. The conductive particles 320 may be uniformly dispersed in the matrix. The conductive particles 320 may be evenly dispersed throughout an entirety of the matrix 310.

Each of the conductive particles 320 may comprise a metallic material. However, the present disclosure is not limited thereto. The conductive particles 320 may include the same or similar material as or to that of the sensing electrode described above.

Each of the conductive particles may be spherical, and each particle may have a particle size of nanometer (nm) or micrometer (μm). However, it should be understood that the present disclosure is not limited thereto, and that each of the conductive particles 320 may have a polygonal shape such as a triangle, a square, or the like.

The conductive particles 320 may be spaced apart from one another in the matrix 310 at regular intervals. For example, the conductive particles 320 may be spaced apart from one another at regular intervals or at random intervals within the matrix 310.

The conductivity conversion member 300 may be disposed on the first sensing electrode 211 and the second sensing electrode 212 to allow or disallow electric connection between the first sensing electrode 211 and the second sensing electrode 212.

That is, the conductivity conversion member 300 may have conductivity or non-conductivity depending on a signal due to an external touch or the like, thereby to allow or disallow electric connection between the first sensing electrode 211 and the second sensing electrode 212.

Referring to FIG. 23, when an external touch or signal is not applied to the conductivity conversion member 300, the first sensing electrode 211 and the second sensing electrode 212 may be insulated from each other.

That is, the first sensing electrode 211 and the second sensing electrode 212, which are spaced apart from each other, may be insulated from each other via the matrix 310.

That is, the conductivity conversion member may have non-conductivity when an external touch or signal is not applied thereto.

Referring to FIG. 24, when an input device such as a finger touches the conductivity conversion member 300 and, then, a pressure is applied to the conductivity conversion member 300, the electrical connection between the first sensing electrode 211 and the second sensing electrode 212 may be realized.

More specifically, when the pressure is transferred onto the conductivity conversion member 300, a spacing between adjacent conductive particles 320 dispersed within the matrix 310 may vary. That is, when the pressure is transferred onto the conductivity conversion member 300, the spacing between the adjacent conductive particles 320 dispersed in the matrix 310 may be reduced.

That is, a first average spacing d1 between the adjacent conductive particles 320 when an external touch or the like is not applied to the conductivity conversion member 300 as shown in FIG. 23 is smaller than a second average spacing d2 between the adjacent conductive particles 320 when the external touch or the like is applied to the conductivity conversion member 300 as shown in FIG. 24.

Accordingly, the first sensing electrode 211 and the second sensing electrode 212, which are spaced apart from each other may be electrically connected to each other via the conductive particles 320. That is, the first sensing electrode 211, the second sensing electrode 212, and the conductive particles 320 may be electrically connected to each other via a tunneling effect, thereby to allow the electric connection between the first sensing electrode 211 and the second sensing electrode 212.

That is, the conductivity conversion member 300 may have conductivity when an external touch or signal is applied thereto.

The first sensing electrode 211 and the second sensing electrode 212 may be spaced apart from each other by a predetermined distance D.

More specifically, the spacing D between the first sensing electrode 211 and the second sensing electrode 212 may be between about 20 μm and about 100 μm. More specifically, the spacing D may be in a range of about 30 μm to about 90 μm. More specifically, the spacing D may be in a range of about 40 μm to about 80 μm.

When the spacing D is smaller than about 20 μm, the first sensing electrode 211 and the second sensing electrode 212 is so close to each other that when an external touch or signal is not applied to the conductivity conversion member 300, the first sensing electrode 211 and the second sensing electrode 212 may be electrically connected to each other via short-circuit therebetween depending on tolerances or errors in the production process thereof.

Further, when the spacing D is greater than about 100 μm, the first sensing electrode 211 is so far away from the second sensing electrode 212 that when an external touch or signal is applied to the conductivity conversion member 300, the tunneling effect of the conductive particles is insufficient, thereby to disallow the electrical connection between the first sensing electrode 211 and the second sensing electrode 212.

Referring to FIG. 25, the touch sensor according to the fourth embodiment may further include a cover substrate 110. The cover substrate 110 may be disposed on the conductivity conversion member 300.

The cover substrate 110 may comprise glass or plastic. More specifically, the cover substrate 110 may comprise the same or similar material as or to that of the substrate 100 described above.

A thickness of the touch sensor may be about 200 μm or less. That is, the thickness of the touch sensor in which the substrate 100, the conductivity conversion member 300, and the cover substrate 110 are laminated may be about 200 μm or less.

More specifically, a distance from a bottom face of the substrate 100 to a top face of the cover substrate 110 may be smaller than about 200 μm.

Since the touch sensor according to the fourth embodiment may be realized with a slim thickness of about 200 μm or less, when the touch sensor is applied to a touch device or the like, an increase in thickness resulting from the touch sensor may be prevented. Thus, a thickness of the touch device may be reduced.

For example, the touch sensor according to the fourth embodiment may be applied to the buttons B in FIG. 18. That is, the touch window including the touch sensor according to the fourth embodiment may be reduced in thickness by using the conductivity conversion member.

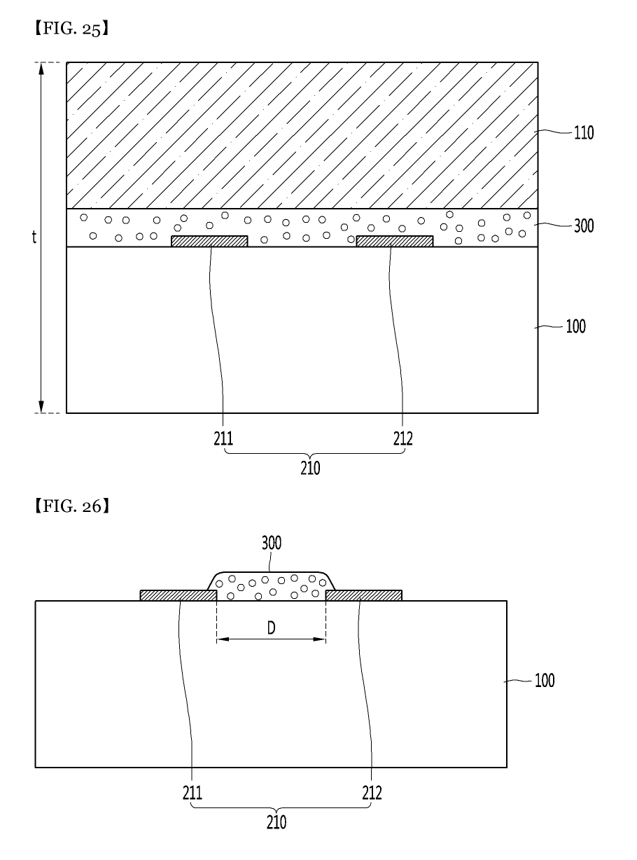

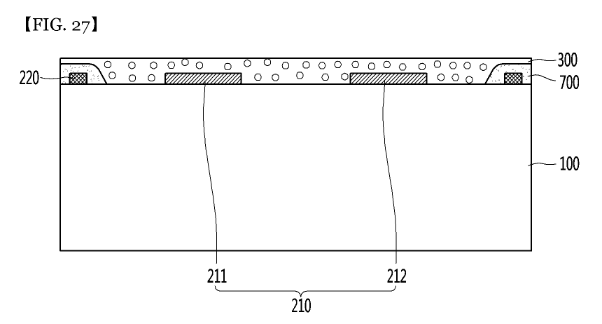

FIG. 26 is a cross-sectional view of a touch sensor according to another embodiment of the present disclosure.

Referring to FIG. 26, an conductivity conversion member 300 of the touch sensor according to another embodiment may be partially disposed on the substrate.

For example, the conductivity conversion member 300 may be disposed on the substrate 100 while the conductivity conversion member 300 has a width greater than the spacing D between the first sensing electrode 211 and the second sensing electrode 212. Accordingly, the conductivity conversion member 300 may be disposed between the first sensing electrode 211 and the second sensing electrode 212 such that the conductivity conversion member 300 surrounds one entire side face and a partial top face of each of the first sensing electrode 211 and the second sensing electrode 212.

More specifically, the conductivity conversion member 300 may be partially disposed on a top face of each of the first sensing electrode 211 and the second sensing electrode 212. Furthermore, the conductivity conversion member 300 may extend between an inner side face of the first sensing electrode 211 and an inner side face of the second sensing electrode 212.

Accordingly, the touch sensor according to this embodiment may have reduction in an area in which the conductivity conversion member is disposed, compared to a case where the conductivity conversion member is disposed on an entire face of the substrate. This may reduce the process cost.

FIG. 27 is a cross-sectional view of a touch sensor according to still another embodiment of the present disclosure.

Referring to FIG. 27, the touch sensor according to this embodiment may further include a protective layer 700.

More specifically, the touch sensor may further include a wiring electrode 220 connected to at least one of the first sensing electrode 211 and the second sensing electrode 212, wherein the wiring electrode 220 is disposed on the substrate 100. The protective layer 700 may be disposed on the wiring electrode 220.

In FIG. 27, each of wiring electrodes 220 is disposed on each of both opposing ends of the substrate 100. However, the present embodiment is not limited thereto. A plurality of the wiring electrodes 220 may be disposed.

Each protective layer 700 may prevent shorting of the wiring electrodes 220. That is, when a signal such as a touch input is applied to the conductivity conversion member 300 to generate a pressure, each protective layer 700 may prevent the wiring electrodes 220 from being short-circuited via the conductive particles.

That is, each protective layer 700 may be an insulating layer for insulating the wiring electrodes.

Each protective layer 700 may include an insulating material. For example, the protective layer 700 may comprise the same or similar material as or to that of the matrix described above.

The touch sensor according to the fourth embodiment may include the conductivity conversion member. Accordingly, a separate proximity sensor may be omitted. That is, an overall thickness of the touch sensor may be reduced compared to a case where the proximity sensor is disposed on the sensing electrode.

In addition, the touch sensor according to the fourth embodiment may generate a direct digital signal. That is, when a pressure is generated by a touch input or the like onto the conductivity conversion member, the first and second electrodes may be electrically connected to each other to generate a digital signal.

Accordingly, a separate driver chip for converting an analog signal into a digital signal is not required, thereby simplifying a structure of the touch sensor.

Furthermore, since the power used in the driver chip is not required, the electrical efficiency of the touch sensor may be improved.

Thus, the touch sensor according to the fourth embodiment may have a slim thickness and may have improved electrical efficiency.

That is, the touch window including the touch sensor according to the fourth embodiment may have reduction in a thickness in an area where the touch sensor is disposed, and thus may have improved flexibility.

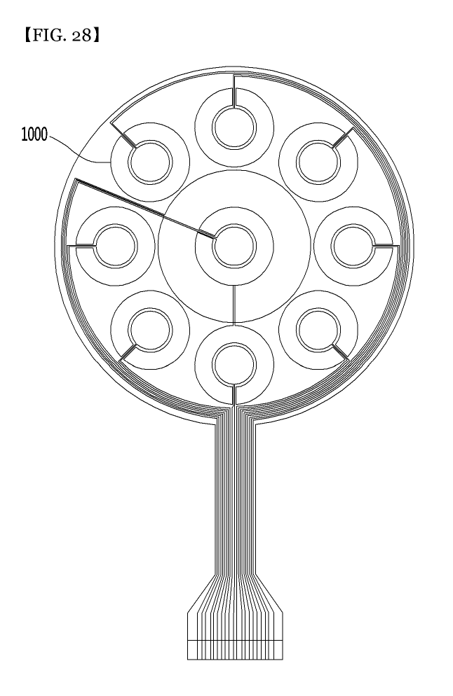

FIG. 28 illustrates a touch device including a touch sensor according to the fourth embodiment.

Referring to FIG. 28, touch sensors 1000 may be arranged on a central area and along a circumferential area around the central area of the touch device. That is, each touch sensor 1000 may be disposed on each region based on each role of each touch sensor.

For example, a central touch sensor disposed on the central area may perform an on-off function of the touch device. Furthermore, each of the touch sensors arranged along the circumferential area around the central area of the touch device may perform a function of controlling each directional operation based on each region.

In FIG. 28, each of the touch sensor 1000 and the touch device is circularly formed. However, the present disclosure is not limited thereto. Each of the touch sensor and the touch device may be polygonal or hemispherical.

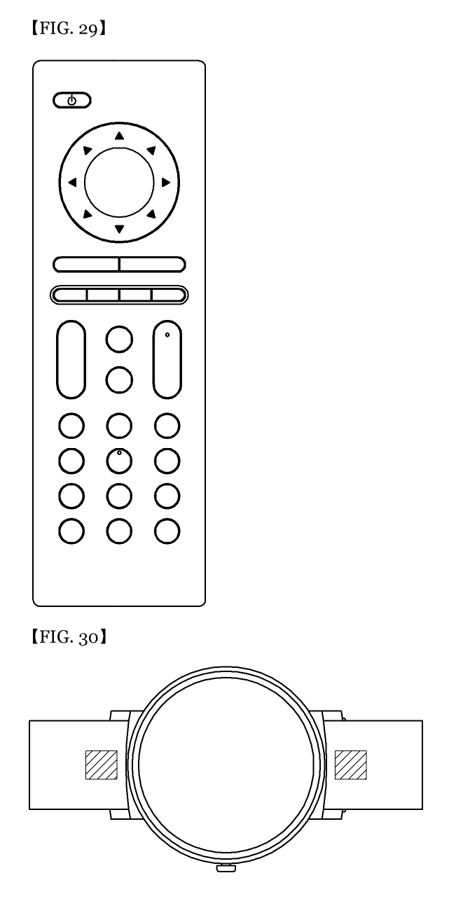

FIGS. 29 to 32 are views showing a touch device.

Referring to FIG. 29, a remote controller is shown as an example of a touch device. In the remote controller, a direction manipulation button and/or a confirmation button may be embodied as the touch sensor.

For example, the confirmation button and the direction manipulation button may be embodied by disposing the touch sensors so as to have a pattern as shown in FIG.

For example, a touch sensor disposed on a central area of the remote controller may be used for the confirmation button of the remote controller. More specifically, by inputting the confirmation button of the remote controller, an application corresponding to an icon displayed on the display device, that is, the display screen, may be executed.

Furthermore, the circumferential touch sensors may be used for direction manipulation buttons of the remote controller. More specifically, by inputting each direction manipulation button of the remote controller, a cursor may be moved toward an icon displayed on the display device, that is, the display screen, based on each position of each circumferential touch sensor along the circumferential area.

The functions of the touch sensors according to the fourth embodiment are merely illustrative. Thus, the touch sensors according to the fourth embodiment may perform various functions.

Referring to FIG. 30, a touch sensor according to the fourth embodiment may be disposed on at least one of a band portion of a watch and a rim portion of the watch. Therefore, the touch device including the touch sensor according to the fourth embodiment may be slimmer or lighter. Furthermore, the touch device including the touch sensor according to the fourth embodiment may have improved battery efficiency. Therefore, the present touch sensor may be applied to a wearable touch device or the like.

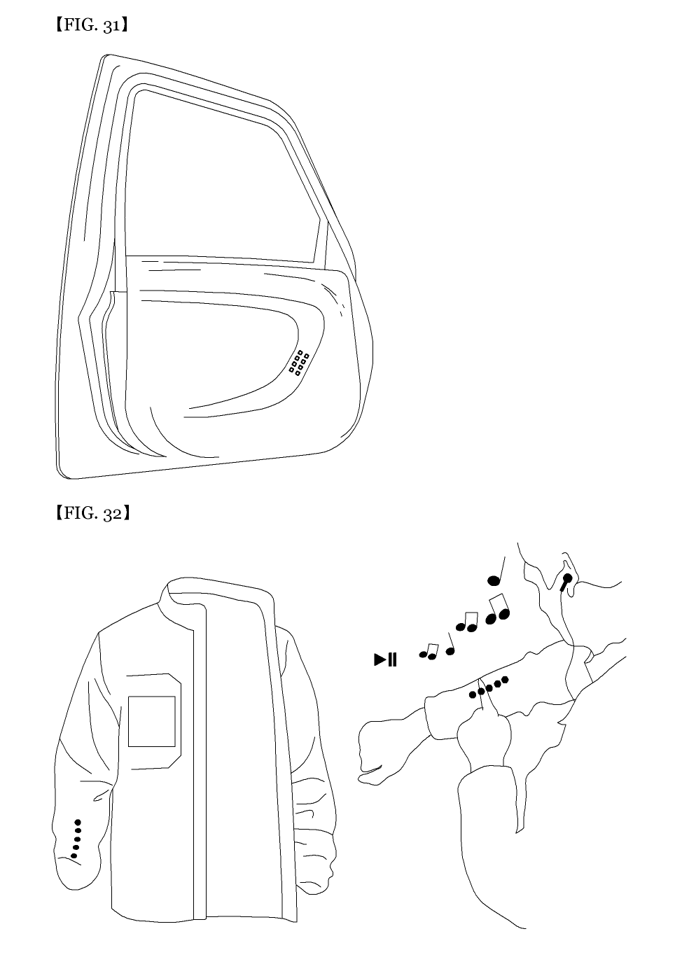

Referring to FIG. 31, the touch sensor according to the fourth embodiment may be applied not only to a wearable touch device, but also to a button unit inside an automobile.

The touch sensor may be applied to various parts of the vehicle to which the touch sensor applicable. Therefore, the touch sensor according to the present embodiment may allow the user to easily operate the button unit while the user is driving.

In addition, referring to FIG. 32, the touch sensor according to the fourth embodiment may be applied to smart clothes. That is, the touch sensor according to the fourth embodiment may be applied to smart clothes because of the small thickness, small weight, and high power efficiency of the touch sensor.

However, the present disclosure is not limited thereto. It goes without saying that such a touch device may be used for various electronic products.

The features, structures, effects and the like described in the above embodiments are included in at least one embodiment of the present disclosure, and are not necessarily limited to only one embodiment. Furthermore, the features, structures, effects, and the like illustrated in the embodiments may be combined with each other or modified or varied for other embodiments by those skilled in the art. Accordingly, it is intended that such modifications, variations and combinations fall within the scope of the appended claims and their equivalents.

In addition, the above-described embodiments are merely examples, but the present disclosure is not limited thereto. It will be understood by those skilled in the art that various changes in form and details may be made therein without departing from the spirit and scope of the disclosure as defined by the appended claims. For example, each component specifically illustrated in the embodiments may be modified and replaced. Such modifications and substitutions are to be construed as being included within the scope of the present disclosure as defined by the appended claims.

1. A touch window comprising:
a cover substrate;
a resin layer on the cover substrate;
a substrate on the resin layer; and
an electrode having a pattern is in direct contact with the substrate,
wherein the resin layer has a viscosity of 1000 cps to about 2000 cps, and
wherein the resin layer has a thickness in a range of 1 μm to 10 μm.

2. The touch window of claim 1, wherein the resin layer comprises an adhesive material.

3. The touch window of claim 1, wherein the resin layer comprises at least one of a photo-curable resin and a thermosetting resin.

4. The touch window of claim 1, wherein the resin layer has a modulus of 1.5×10⁵ Pa to 3.0×10⁵ Pa.

5. The touch window of claim 1, wherein the resin layer has an adhesion in a range of 10 N/cm to 30 N/cm.

6. The touch window of claim 1, wherein one face of the resin layer includes a curved face.

7. The touch window of claim 1, wherein the substrate has a thickness in a range of 30 μm to 70 μm.

8. The touch window of claim 1, wherein the electrode include a sensing electrode and a wiring electrode connected to the sensing electrode, wherein at least one of the sensing electrode and the wiring electrode is formed in a mesh shape.

9. The touch window of claim 8, wherein the substrate comprises an active area and an inactive area, wherein the sensing electrode comprises a first sensing electrode and a second sensing electrode, wherein both of the first sensing electrode and the second sensing electrode are disposed on the same face of the substrate.

10. The touch window of claim 9, wherein the wiring electrode extends from the active area to the inactive area.

11. The touch window of claim 1, wherein the electrode comprises two or more electrode layers,
wherein the electrode layers comprise a first layer and a second layer,
wherein the first layer comprises a photosensitive material.

12. The touch widow of claim 11, wherein the first layer is a non-conductive layer, and the second layer is a conductive layer, wherein the second layer is disposed on the first layer.

13. The touch window of claim 12, wherein the conductive layer comprises a conductive polymer.

14. The touch window of claim 11, wherein the electrode layer comprises at least one of a sensing electrode and a wiring electrode, wherein at least one of the sensing electrode and the wiring electrode is formed in a mesh shape.

15. The touch window of claim 1, wherein the electrode comprises a first electrode and an electrode part,
wherein the electrode part includes a base layer and a second electrode disposed on the base layer.

16. The touch window of claim 15, wherein the first electrode and the second electrode comprise different materials.

17. The touch window of claim 16, wherein the first electrode comprises a conductive polymer, wherein the second electrode comprises a nanowire.

18. The touch window of claim 15, wherein the electrode part is in direct contact with at least one of the substrate and the first electrode.

19. The touch window of claim 15, wherein the base layer comprises a photosensitive material.

20. The touch window of claim 15, wherein the electrode layer comprises at least one of a sensing electrode and a wiring electrode, wherein at least one of the sensing electrode and the wiring electrode is formed in a mesh shape.
